(19) United States
(12) Patent Application Publication
(10) Pub. No.: US 2021/0117107 A1
(43) Pub. Date: Apr. 22, 2021

(54) METHOD FOR STORING UAV SYSTEM LOG AND UAV IMAGE TRANSMISSION SYSTEM

(71) Applicant: AUTEL ROBOTICS CO., LTD., Shenzhen (CN)

(72) Inventor: Zhaozao Li, Shenzhen (CN)

(21) Appl. No.: 17/136,202

(22) Filed: Dec. 29, 2020

Related U.S. Application Data
(63) Continuation of application No. PCT/CN2019/094603, filed on Jul. 3, 2019.

(30) Foreign Application Priority Data
Jul. 9, 2018 (CN) 2018107445080

(51) Int. Cl. G06F 3/06

(52) U.S. Cl. CPC G06F 3/0619; G07C 5/008; G06F 3/0679; G06F 3/0644

(57) ABSTRACT

Embodiments of the present invention relate to a method for storing a UAV system log and a UAV image transmission system. The method for storing a UAV system log includes: generating a run log at an end of a UAV, the run log including an exception log generated when an exception occurs in the UAV system; and storing the exception log into a preset first storage space. With the method, after a UAV system is shipped, exception logs can be exported in time and sent to technicians to locate problems. A routine run log of the system that has a relatively large data volume may be stored in a mass storage device of a UAV or a mobile terminal, and may be used in research and development or test reproduction.

This application is a continuation application of International Application No. PCT/CN2019/094603, filed on Jul. 3, 2019, which claims priority of Chinese Patent Application No. 201810744508.0, filed on Jul. 9, 2018, which is incorporated herein by reference in its entirely.

### BACKGROUND

### Technical Field

The present invention relates to the field of unmanned aerial vehicle (UAV) technologies, and in particular, to a method for storing a UAV system log and a UAV image transmission system.

### Related Art

UAVs are photographing vehicles that grow increasingly popular in recent years. Based on the high maneuverability and flexible position movement of UAVs or aerial vehicles, many angles that are impossible for normal photography can be obtained. Therefore, UAVs are increasingly applied to aerial photography or aerobatics.

A user usually needs to use a dedicated remote control device to control the flight of a UAV. Alternatively, a communication connection is established between the remote control device and a mobile terminal, and images photographed by an aerial-photography UAV are played on demand in real time.

In a UAV system, data transmission is performed based on wireless communication to implement image transmission, remote control or the like, which is highly susceptible to a surrounding environment. Therefore, during actual running, the UAV system may encounter many technical problems on site that are unpredictable or difficult to reproduce in laboratories or off-site routine tests.

How to accurately record on-site conditions of the UAV system, provide basic analysis data, and locate problems or faults in the UAV system for technicians is a problem that urgently needs to be resolved.

### SUMMARY

To resolve the foregoing technical problem, embodiments of the present invention provide a method for storing a UAV system log and a UAV image transmission system that can provide complete UAV log information during running.

To resolve the foregoing technical problem, an embodiment of the present invention provides the following technical solution: a method for storing a UAV system log. The storage method includes: generating a run log at an end of a UAV, the run log including an exception log generated when an exception occurs in the UAV system; and storing the exception log into a preset first storage space.

Optionally, the preset storage space is private flash of the UAV.

Optionally, the storing the exception log into a preset first storage space includes: sequentially writing exception logs into the preset first storage space according to an order in which the exception logs are generated.

Optionally, the preset first storage space includes an identifier storage region at a head and a content storage region, and the sequentially writing exception logs into the preset first storage space according to an order in which the exception logs are generated includes:

determining whether the length of a to-be-written exception log is less than the remaining length of the content storage region;

if yes, writing the to-be-written exception log into the content storage region from the end position of a previously written exception log; or

if not, writing the to-be-written exception log into the content storage region from the start position of an earliest written exception log, to overwrite the earliest written exception log; and

writing the end position of the to-be-written exception log into the identifier storage region.

Optionally, the method further includes: storing the run log into a mass storage device of the UAV.

To resolve the foregoing technical problem, an embodiment of the present invention further provides the following technical solution: a method for storing a UAV system log. The storage method includes: generating a run log at an end of a remote control, the run log including an exception log generated when an exception occurs in the remote control; and storing the exception log into a preset second storage space.

Optionally, the preset storage space is private flash of the remote control.

Optionally, the storing the exception log into a preset second storage space includes: sequentially writing exception logs into the preset second storage space according to an order in which the exception logs are generated.

Optionally, the preset second storage space includes an identifier storage region at a head and a content storage region, and the sequentially writing exception logs into the preset second storage space according to an order in which the exception logs are generated includes:

determining whether the length of a to-be-written exception log is less than the remaining length of the content storage region;

if yes, writing the to-be-written exception log into the content storage region from the end position of a previously written exception log; or

if not, writing the to-be-written exception log into the content storage region from the start position of an earliest written exception log, to overwrite the earliest written exception log; and

writing the end position of the to-be-written exception log into the identifier storage region.

Optionally, the method further includes: storing the run log into a mass storage device of the remote control.

To resolve the foregoing technical problem, an embodiment of the present invention further provides the following technical solution: a UAV image transmission system. The UAV image transmission system includes a UAV-side image transmission module and a ground-side image transmission module, where

the UAV-side image transmission module and the ground-side image transmission module are connected by a wireless network, where the UAV-side image transmission module includes at least one first memory, a preset first storage space being provided in the first memory, the preset first storage space being used to store an exception log generated when an exception occurs in a UAV; and

the ground-side image transmission module includes at least one second memory, a preset second storage space being provided in the second memory, the preset second storage space being used to store an exception log generated when an exception occurs in a UAV.

Optionally, the UAV image transmission system further includes an image acquisition device and a mobile terminal device, where the UAV-side image transmission module is communicatively connected to the image acquisition device by an Ethernet, and the ground-side image transmission module is communicatively connected to the mobile terminal device by a USB.

Optionally, the image acquisition device is connected to a mass storage device of the UAV, and the mobile terminal device is connected to a mass storage device of the remote control, where

the UAV-side image transmission module is configured to transmit, through the Ethernet, a run log generated at an end of the UAV to the mass storage device of the UAV for storage; and the ground-side image transmission module is configured to transmit, through the connection of the USB, a run log generated at an end of the remote control to the mass storage device of the mobile terminal for storage, where

the run log generated at the end of the UAV includes the exception log generated when an exception occurs in the UAV, and the run log generated at the end of the remote control includes the exception log generated when an exception occurs in the remote control.

Optionally, each of the first memory and the second memory is flash, where a storage address of S bytes is assigned in the flash as each preset storage space, where the first N bytes are used as an identifier storage region to store the end position of the exception log, and an (N+1)^{th} to an S^{th} bytes are used as a content storage region to store the exception log.

Compared with the prior art, according to the method for storing a UAV system log and the UAV image transmission system that are provided in the embodiments of the present invention, an exception log is stored in private flash of an image transmission system. In this way, after a UAV system is shipped, exception logs can be exported in time and sent to technicians to locate problems.

A complete run log of the UAV system that has a relatively large data volume may be separately stored in a mass storage device of a UAV or a remote control, and may be used in research and development or test reproduction.

### BRIEF DESCRIPTION OF THE DRAWINGS

One or more embodiments are described by way of example with reference to the corresponding figures in the accompanying drawings, and the exemplary descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an application environment according to an embodiment of the present invention;

FIG. 2 is a structural block diagram of a remote control according to an embodiment of the present invention;

FIG. 3 is a structural block diagram of a UAV system according to an embodiment of the present invention;

FIG. 4 is a schematic diagram of storage address division in a first memory according to an embodiment of the present invention;

FIG. 5 is a method flowchart of a method for storing a UAV system log according to an embodiment of the present invention;

FIG. 6 is a method flowchart of a method for writing an exception log according to an embodiment of the present invention;

FIG. 7 is a method flowchart of a method for storing a UAV system log according to another embodiment of the present invention; and

FIG. 8 is a method flowchart of a method for writing an exception log according to another embodiment of the present invention.

### DETAILED DESCRIPTION

For ease of understanding the present invention, the present invention is described in further detail below with reference to the accompanying drawings and specific embodiments. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. In the description of the specification, orientation or position relationships indicated by the terms such as “up”, “down”, “inside”, “outside” and “bottom” are based on orientation or position relationships shown in the accompanying drawings, and are used only for ease and brevity of illustration and description of the present invention, rather than indicating or implying that the mentioned apparatus or element needs to have a particular orientation or needs to be constructed and operated in a particular orientation. Therefore, such terms should not be construed as limiting of the present invention. In addition, terms such as “first”, “second” and “third” are used only for description purpose and shall not be construed as indicating or implying relative importance.

Unless otherwise defined, meanings of all technical and scientific terms used in the specification are the same as that usually understood by a person skilled in the art to which the present invention belongs. Terms used in the specification of the present invention are merely intended to describe objectives of the specific embodiments, and are not intended to limit the present invention. The term “and/or” used in the specification includes any and all combinations of one or more related listed items.

In addition, technical features involved in different embodiments of the present invention described below may be combined with each other as long as no conflict occurs.

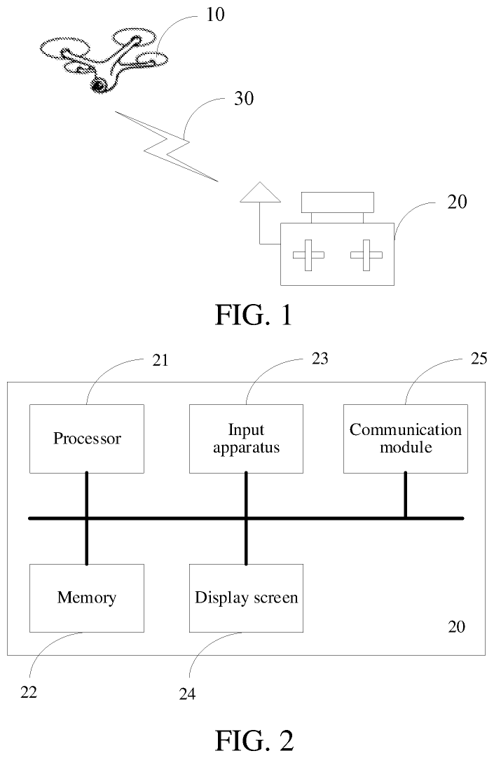

FIG. 1 shows an application environment according to an embodiment of the present invention. As shown in FIG. 1, the application environment includes a UAV 10, a remote control 20 and a wireless network 30.

The UAV 10 may be any type of power-driven UAV, including, but not limited to, a quadrotor UAV, a fixed-wing aircraft and a helicopter model. In this embodiment, the quadrotor UAV is used as an example for description.

The UAV 10 may have a corresponding volume or power according to an actual requirement, to provide a load capacity, a flight speed and a flight mileage that can meet a use requirement. One or more functional modules may further be added to the UAV to enable the UAV to implement more functions.

For example, in some embodiments, the UAV 10 at least has an image acquisition device configured to acquire image information and a mass storage device configured to store the image information. In some other embodiments, the UAV 10 may further provide a fixing support configured to fixedly mount an image acquisition module, so that a user can replace, according to a requirement of the user, the image acquisition device mounted on the UAV 10.

The remote control 20 may be any type of user interaction device configured to operate the UAV. The remote control 20 may be provided with one or more different user interaction devices, to acquire a user instruction or present or feed back information to the user. The interaction devices include, but are not limited to, a button, a display screen, a touchscreen, a speaker and a remote control joystick. For example, the remote control 20 may be provided with a touch display screen. A remote control instruction of the user for the UAV is received by using the touch display screen, and image information is presented to the user by using the touch display screen.

In some embodiments, the remote control 20 may further be connected to an intelligent terminal device or directly implemented by the intelligent terminal device. For example, a software application (APP) matching the UAV 10 may be installed on the intelligent terminal. A user may obtain the image information acquired by the UAV 10 and/or operate the UAV 10 by using the software APP.

In some other embodiments, the remote control 20 may be alternatively a dedicated control device that matches the UAV 10 and can receive image information from the UAV 10 and display the image information by using a built-in or externally connected display screen (for example, a mobile phone).

FIG. 2 is a structural block diagram of the remote control 20 according to an embodiment of the present invention. As shown in FIG. 2, the remote control 20 may include a processor 21, a memory 22, an input apparatus 23, a display screen 24 and a communication module 25.

Any two of the processor 21, the memory 22, the input apparatus 23, the display screen 24 and the communication module 25 are communicatively connected by a bus.

The processor 21 is any type of single-thread or multi-thread processor having one or more processing cores, and is used as the control core of the remote control 20 to obtain data, perform a logical operation function, and deliver an operation processing result.

The memory 22 is used as a non-volatile computer-readable storage medium, for example, at least one magnetic disk storage device, a flash memory, a distributed storage device remotely disposed relative to the processor 21 or another non-volatile solid-state storage device.

The memory 22 may have a program storage region used to store a non-volatile software program, a non-volatile computer-executable program and a module to be invoked by the processor 21 to enable the processor 21 to perform one or more method steps. The memory 22 may further have a data storage region used to store the operation processing result delivered and outputted by the processor 21.

The input apparatus 23 is a user interaction device configured to acquire an instruction inputted by the user, for example, a mouse, a keyboard, a touch panel, a remote control joystick or another input device. The input apparatus 23 receives digit or character information inputted by the user, and provides the digit or character information to the processor 21, so that the processor 21 executes a corresponding control instruction.

The display screen 24 is a display device configured to present corresponding data to the user in a particular form, and may be any type of display, for example, an LED display, a picture tube display or an LCD display. The display screen 24 receives display information outputted by the processor 21, and correspondingly converts the display information into image information to provide the image information to the user.

The communication module 25 is a functional module configured to establish a communication connection with the UAV 10 and provide a physical channel. The communication module 25 may be any type of wireless or wired communication module, for example, a Wi-Fi module or a Bluetooth module.

The wireless network 30 may be a wireless communication network in which a data transmission channel between two nodes can be established based on any type of data transmission principle. For example, the wireless network may be a Bluetooth network, a Wi-Fi network, a wireless cellular network and a combination of various wireless communication networks at different signal frequency bands.

In some embodiments, the wireless network 30 may be a radio frequency transmission network in the 2.4 GHz frequency band. Corresponding radio frequency modules are disposed on the UAV 10 and the remote control 20, and a corresponding communication link is established, to implement data transmission between the UAV 10 and the remote control 20.

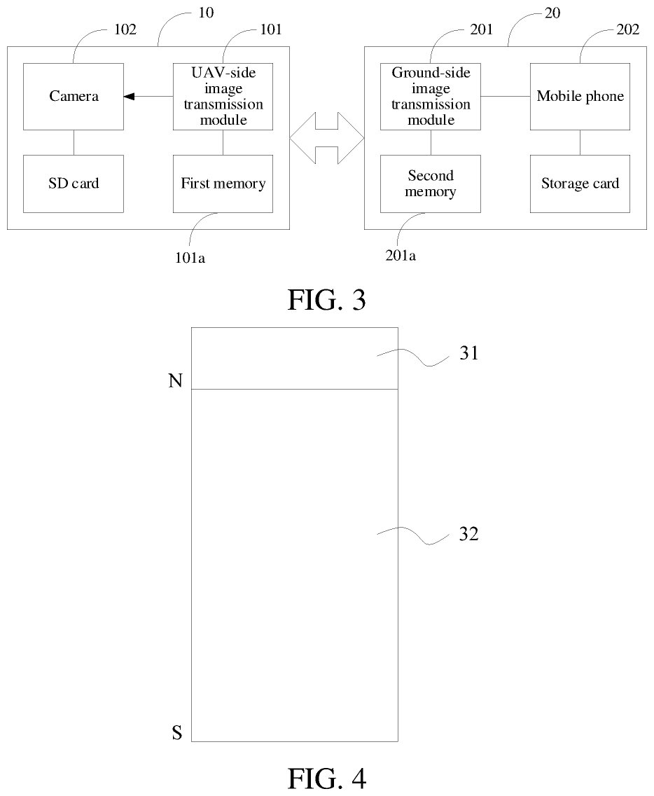

To implement real-time image information transmission between the UAV 10 and the remote control 20, referring to FIG. 3, an aircraft image transmission system may be integrated in the UAV system. The aircraft image transmission system may include a UAV-side image transmission module 101 and a camera 102 that are applied on the side of the UAV 10, and a ground-side image transmission module 201 and a mobile phone 202 that are applied on the side of the remote control 20.

The camera 102 may be a camera with a suitable resolution or an action camera. In the embodiment shown in FIG. 3, only the camera 102 is used as an example.

It may be understood that in other embodiments, a corresponding image acquisition device, for example, a camera, configured to shoot a video or an image may be selected according to an actual case. This is not strictly limited herein.

The UAV-side image transmission module 101 may establish a communication connection with the image acquisition device of the UAV in a suitable communication manner, to obtain an image from the image acquisition device. Specifically, the UAV-side image transmission module 101 may establish a communication connection with the image acquisition device through an Ethernet.

The ground-side image transmission module 201 establishes a communication connection with the mobile phone 202, to receive image information sent by the UAV-side image transmission module 101 and provide the image information to the mobile phone 202.

The mobile phone 202 may be specifically any type of terminal device configured to implement relevant operations. In the embodiment shown in FIG. 3, only the mobile phone 202 is used as an example. It may be understood that in other embodiments, another corresponding mobile terminal device, for example, a tablet computer, a laptop computer, or some wearable intelligent devices, that can present image information to the user may be alternatively selected according to an actual case.

Specifically, the ground-side image transmission module 201 may establish a communication connection to the mobile phone 202 through a USB cable.

Data exchange between the UAV-side image transmission module 101 and the ground-side image transmission module 201 may be implemented through a 2.4 GHz radio frequency communication network or another type of wireless communication network, to transmit image data acquired by the camera.

With the UAV system running, the UAV-side image transmission module 101 may continuously generate a run log used to record a running status of the UAV. Similarly, the ground-side image transmission module 201 may also generate, during the running of the UAV system, a run log that records a running status of the remote control or a data instruction receiving status.

The run log is information related to the UAV and the remote control, for example, a machine status of the running of the UAV (for example, electricity consumption, a rotational speed of a motor and a battery status), a moving trajectory (for example, an altitude, a flight distance and a speed) of the UAV and an input instruction of the remote control. The run log records all detailed information in the running process of the entire UAV system, and may be provided to research and development personnel or skilled persons, to be used as basic data.

The researchers and developers or technicians can effectively and accurately restore a site of the UAV system by using the basic information provided by the run logs of the UAV and the remote control, locate a problem and provide a feasible solution.

In the running process of the UAV system, a normal use state and an abnormal state are usually included. In this embodiment, a log generated in an abnormal state (for example, a fault or a remote control failure) is referred to as an exception log. Generally, the run log has a very large data volume (for example, 1 Mib per second), and the data volume of the exception log usually occupies only a very small part (usually tens of K) of the run log.

In some embodiments, the UAV-side image transmission module 101 and the ground-side image transmission module 201 may be respectively provided with a first memory 101a and a second memory 201a. The first memory 101a and the second memory 201a may be respectively private flash memories (FLASH) of the UAV-side image transmission module 101 and the ground-side image transmission module 201, or other memories of a suitable type. A first storage space is provided in the private FLASH of the UAV-side image transmission module 101, and a second storage space is provided in the private FLASH of the ground-side image transmission module 201. The first storage space and the second storage space are used as preset storage spaces to store corresponding exception log data or instruction programs.

As shown in FIG. 3, some mass storage devices, for example, SD cards or TF cards, that are configured to store image data are usually provided in the camera 102. Further, the mobile phone 202 also has a corresponding mass storage device, for example, various different types of expandable storage cards inserted into the mobile phone 202. Each of the mass storage devices in the camera 102 and the mobile phone 202 has the feature of a large storage space and has a large storage capacity, thereby meeting the requirement of storing a large amount of data.

Based on the differences between the run log and the exception log in data volume and data application scenario, in this embodiment of the present invention, the UAV-side image transmission module 101 may store and write the exception log into the first storage space of the first memory 101a, and send, through the Ethernet, the run log to the mass storage device (for example, an SD card) in the image acquisition device for storage. The ground-side image transmission module 201 may write the generated exception log into the second storage space of the private second memory 201a, and send, in the manner of USB connection, the run log with a large data volume to the mass storage device (for example, a storage card) in the mobile phone 202 for storage.

Although only the camera and the mobile phone are used as examples for description in FIG. 3, a person skilled in the art may further replace, adjust, or combine the camera and the mobile phone with other devices, provided that mass storage devices that respectively establish data connections with the UAV side and the ground side can be formed.

The exception logs stored in the private FLASH of the UAV-side image transmission module 101 and the ground-side image transmission module 201 can be easily exported and provided, in a network form such as an http server, to corresponding research and development personnel or skilled persons for problem positioning. This export manner can facilitate the user to diagnose the UAV in time when a problem or exception occurs during use of the UAV, and provide a corresponding solution to the user.

The run log stored in the mass storage device may be used as long-term stored data, and is used when the skilled person performs subsequent research and development or test scenario construction, and reproduces detailed problems of the UAV. The mass storage device can ensure that there is sufficient space to store the run log that has a relatively large data volume.

In some other embodiments, for ease of exporting exception logs according to a particular rule and time order, the first storage space and the second storage space that are respectively provided in the first memory 101a and the second memory 102a may be correspondingly set, and a suitable write rule may be used.

FIG. 4 is a schematic diagram of storage address division in the first storage space or the second storage space according to an embodiment of the present invention. As shown in FIG. 4, the preset first or second storage space may be divided into two parts: an identifier storage region 31 and a content storage region 32.

The first N bytes are used as the identifier storage region to store the end position of the exception log. The remaining storage space is the content storage region used to store the specific content of the exception log. A person skilled in the art may set N to any suitable integer according to an actual requirement. Specifically, N may be set to 4. That is, the first four bytes are reserved to record or store the end position P of the exception log, to implement corresponding indication.

Based on the schematic diagram of address assignment in the preset first or second storage space shown in FIG. 4, exception logs may be sequentially written into and exported from the first or second memory according to a chronological order of generation time in the following manner.

It is assumed that the length of the exception log written each time is L bytes, the end position is P, and the size of the content storage region is S bytes.

A write process is as follows: First, it is calculated whether P+L is less than S (that is, whether a remaining space of the content storage region 32 is sufficient to write or accommodate a current exception log). If yes, the log is written at the position P, and then it is set P=P+L. If not, after it is set P=0, the current exception log is written at the position P (that is, the current exception log is written into the first address of the content storage region to overwrite a previously written address), and then it is set P=P+L.

At last, the value of the end position P is written into the identifier storage region.

An export process is as follows: First, content in the identifier storage region is read, to determine the end position P of a latest written exception log. Then, when P=0, all exception logs in the content storage region are exported directly in the sequence from 0 to S.

When P is between 0 and S, content in the content storage region is first exported in the sequence from the position P to S, and then the remaining content is exported in the sequence from 0 to S, thereby providing exception logs arranged in a sequence of generation time.

In an embodiment, storage address division in the second memory is the same as the storage address division in the first memory.

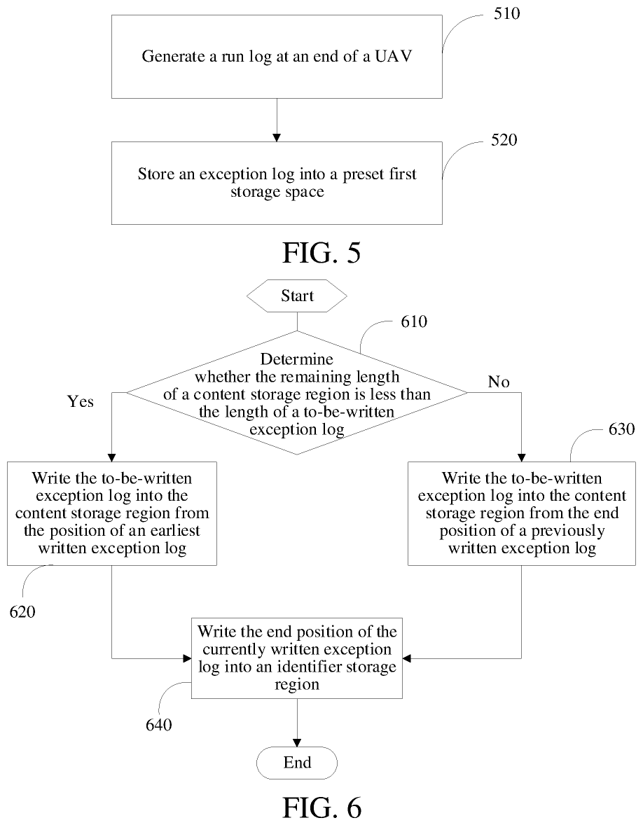

FIG. 5 shows a UAV system log storage method according to an embodiment of the present invention. The method shown in FIG. 5 is performed by a hardware device at an end of a UAV, to provide a run log related to the UAV. As shown in FIG. 5, the method may include the following steps:

510: Generate a run log at an end of a UAV. According to the foregoing embodiment, the run log refers to data that records in detail running status information of the UAV at different times or at different moments. The log truly records a running process of the UAV, and can provide rich data for problem positioning or site reproduction. The run log includes an exception log generated when an exception occurs in the UAV system.

Content that needs to be specifically recorded by the run log or related parameters and items may be selectively set by a skilled person according to an actual situation. In some embodiments, the run log may also be adjusted during use, to change, increase, or reduce information items to be recorded by the run log.

520: Store the exception log into a preset first storage space.

The exception log is a run log generated when a fault or another abnormal case occurs in the UAV system. The run log usually represents an abnormal working state of the UAV. It may be understood that these exception logs have a relatively small data volume (for example, about tens of K), and may be stored into an internal memory of an image transmission system or a UAV core control system (for example, private flash of the UAV), so that the exception logs can be transmitted to researchers and developers or a technical support department in time through an external network or an http server, to locate the problem of the UAV.

In some other embodiments, the run log is further stored into a mass storage device of the UAV.

It may be understood that the run log of the running of the UAV system has a relatively large data volume (for example, 1 Mib per second), and needs to be stored into a mass storage device to meet the requirement of data storage, to provide rich data.

The mass storage device provided in the UAV may be specifically determined according to an actual situation, and depends on a functional module included or installed in the UAV system. For example, the mass storage device may be an SD card in a camera that is used to store an image.

In this embodiment, the preset first storage space is still a limited space, and exception logs are continuously generated. Therefore, to ensure that the exception logs are sequential and can be used, the following specific step may be adopted:

sequentially writing exception logs into the preset storage space according to an order in which the exception logs are generated.

The preset storage space has addresses arranged in a particular order. In the process of writing the exception logs, the exception logs are sequentially written according to a chronological order, and a subsequent exception log is written into a first address right behind the end position of the previous exception log.

In some embodiments, to resolve the conflict between the limited preset first storage space and the continuous generation of the exception log data volume, the following storage manner may be specifically adopted:

First, it is determined whether the length of a to-be-written exception log is less than a remaining length of the content storage region.

If yes, the to-be-written exception log is written into the content storage region from the end position of a previously written exception log.

If not, the to-be-written exception log is written into the content storage region from the start position of an earliest written exception log, to overwrite the earliest written exception log.

In this manner, when the preset first storage space is insufficient to accommodate a new exception log to be written, the to-be-written exception log is written by overwriting the earliest written exception log that is originally stored in the preset storage space.

Specifically, FIG. 6 is a specific flowchart of implementing the exception log storage method disclosed in the foregoing method embodiment. As shown in FIG. 6, the process of writing the exception log into the first memory may include the following steps:

610: Determine whether the remaining length of the content storage region is less than the length of the to-be-written exception log, where the preset storage space is divided into the identifier storage region at the head and the content storage region.

If yes, step 620 is performed, or if not, step 630 is performed.

620: Write the to-be-written exception log into the content storage region from the position of a first written exception log, to overwrite the first written exception log. That is, the current exception log is written starting from the head (first address) of the content storage region.

630: Write the to-be-written exception log into the content storage region from the end position of a previously written exception log.

That is, the current exception log is written starting from the end position P of the previous exception log.

640: Write the end position of the currently written exception log into the identifier storage region.

The end position is used to mark the position of the current latest exception log in the preset storage space, to ensure that the exception logs can be exported accurately according to a time order.

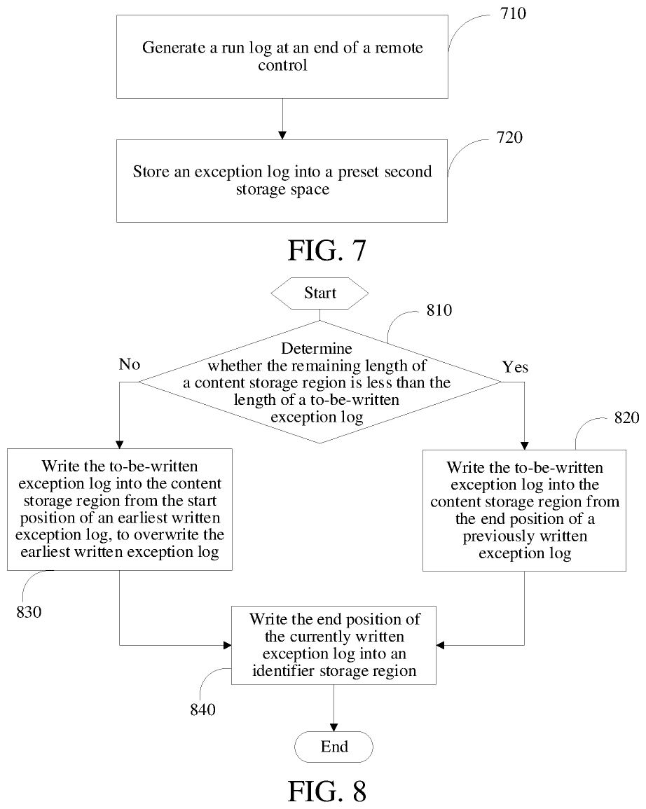

FIG. 7 shows a method for storing a UAV system log according to another embodiment of the present invention. The method shown in FIG. 7 is performed by a hardware device at an end of a remote control, to provide a run log related to the remote control. As shown in FIG. 7, the method may include the following steps:

710: Generate a run log at an end of a remote control.

The end of the remote control is a ground end corresponding to an end of a UAV in a UAV system. The remote control end includes, but is not limited to, a remote control, and may further include another suitable device, for example, a smartphone or a tablet computer of the user. The run log at the remote control end may usually include a device status related to user interaction or a transmission status of an instruction.

720: Store the exception log into a preset second storage space.

Similar to the foregoing end of the UAV, the run log at the end of the remote control also includes the exception log generated when an exception occurs in the remote control. The exception log has a relatively small data volume, and therefore can be stored in the preset second storage space, to be invoked or sent in time to a technician for use. In some embodiments, the preset storage space may be private flash of the remote control.

In some other embodiments, the run log may further be stored into a mass storage device (for example, a mobile phone connected to the remote control) of the remote control. A complete run log records or includes a relatively large data volume, and needs to be stored in a mass storage device, to ensure that the storage space can meet the storage requirement of the data volume.

As described above, at the end of the remote control, exception logs may also be sequentially written into the preset second storage space according to an order in which the exception logs are generated. The preset second storage space has addresses arranged in a particular order. In the process of writing the exception logs, the exception logs are sequentially written according to a chronological order, and a subsequent exception log is written at a first address right behind the end position of the previous exception log.

Certainly, the second storage space that can be provided by the private flash of the remote control is still limited. Therefore, to ensure that continuously generated exception logs can be written and recorded, the following specific step may be adopted:

writing a currently generated exception log and overwriting a first written exception log in the preset storage space when a remaining length of the preset second storage space is insufficient to write the currently generated exception log.

Specifically, FIG. 8 is a specific flowchart of implementing the exception log storage method disclosed in the foregoing method embodiment. As shown in FIG. 8, the process of writing the exception log into the second storage space may include the following steps:

810: Determine whether the remaining length of the content storage region is less than the length of the to-be-written exception log, where the preset storage space is divided into the identifier storage region at the head and the content storage region.

If yes, step 820 is performed, or if not, step 830 is performed.

820: Write the to-be-written exception log into the content storage region from the end position of a previously written exception log.

830: Write the to-be-written exception log into the content storage region from the start position of a first written exception log, to overwrite the first written exception log.

840: Write the end position of the currently written exception log into the identifier storage region. The end position is used to mark the position of the current latest exception log in the preset storage space, to ensure that the exception logs can be exported accurately according to a time order.

Based on the above, the UAV system log storage method and the UAV image transmission system configured to perform the method that are provided in the embodiments of the present invention can effectively record and store the run log data of the UAV and the remote control in the running process of the UAV system.

An exception log generated in an abnormal case may be directly stored in an internal memory of the UAV or the remote control. After the UAV is shipped in batches, when an exception occurs during use, the user can easily export the exception log from the internal memory, and send the exception log to the http server for the research and development personnel to locate the exception.

Run logs generated during routine running are separately stored in the mass storage devices of the UAV and the remote control (for example, an SD card in the UAV or a storage card in the smartphone). The mass storage devices may record all run logs as basic data, and provide the run logs for further research and development or test reproduction of detailed problems of the UAV.

A person skilled in the art may further realize that the steps in the exemplary data transmission control method described with reference to the embodiments disclosed in this specification can be implemented by electronic hardware, computer software, or a combination thereof. To clearly describe the interchangeability between the hardware and the software, the parts and steps of each example are described generally according to functions in the foregoing descriptions. Whether the functions are implemented by hardware or software depends on particular applications and design constraints of the technical solutions.

A person skilled in the art may use different methods to implement the described functions for each particular application, but this implementation shall not be considered as going beyond the scope of the present invention. The computer software may be stored in a computer-readable storage medium. When being executed, the program may include the processes of the embodiments of the foregoing methods. The storage medium may be a magnetic disk, an optical disc, a read-only memory (ROM), or a random access memory (RAM).

Finally, it should be noted that the foregoing embodiments are merely used to describe the technical solutions of the present invention, but are not intended to limit the present invention. Under the concept of the present invention, the technical features in the foregoing embodiments or different embodiments may be combined, the steps may be implemented in any sequence, and there may be many other changes in different aspects of the present invention. For brevity, those are not provided in detail. Although the present invention is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is:

1. A method for storing an unmanned aerial vehicle (UAV) system log, comprising:
generating a run log at an end of a UAV, the run log comprising an exception log generated when an exception occurs in the UAV; and
storing the exception log into a preset first storage space.

2. The storage method according to claim 1, wherein the preset first storage space is private flash of the UAV.

3. The storage method according to claim 1, wherein the storing the exception log into a preset first storage space comprises:
sequentially writing exception logs into the preset first storage space according to an order in which the exception logs are generated.

4. The storage method according to claim 3, wherein the preset first storage space comprises an identifier storage region at a head and a content storage region, and the sequentially writing exception logs into the preset first storage space according to an order in which the exception logs are generated comprises:
determining whether the length of a to-be-written exception log is less than the remaining length of the content storage region;
if yes, writing the to-be-written exception log into the content storage region from the end position of a previously written exception log; or
if not, writing the to-be-written exception log into the content storage region from the start position of an earliest written exception log, to overwrite the earliest written exception log; and
writing the end position of the to-be-written exception log into the identifier storage region.

5. The storage method according to claim 1, further comprising:
storing the run log into a mass storage device of the UAV.

6. A method for storing an unmanned aerial vehicle (UAV) system log, comprising:
generating a run log at an end of a remote control, the run log comprising an exception log generated when an exception occurs in the remote control; and
storing the exception log into a preset second storage space.

7. The storage method according to claim 6, wherein the preset second storage space is private flash of the remote control.

8. The storage method according to claim 6, wherein the storing the exception log into a preset second storage space comprises:
sequentially writing exception logs into the preset second storage space according to an order in which the exception logs are generated.

9. The storage method according to claim 8, wherein the preset second storage space comprises an identifier storage region at a head and a content storage region, and the sequentially writing exception logs into the preset second storage space according to an order in which the exception logs are generated comprises:
determining whether the length of a to-be-written exception log is less than the remaining length of the content storage region;
if yes, writing the to-be-written exception log into the content storage region from the end position of a previously written exception log; or
if not, writing the to-be-written exception log into the content storage region from the start position of an earliest written exception log, to overwrite the earliest written exception log; and
writing the end position of the to-be-written exception log into the identifier storage region.

10. The storage method according to claim 6, further comprising:
storing the run log into a mass storage device of the remote control.

11. An unmanned aerial vehicle (UAV) image transmission system, comprising a UAV-side image transmission module and a ground-side image transmission module, wherein
the UAV-side image transmission module and the ground-side image transmission module are connected by a wireless network, wherein the UAV-side image transmission module comprises at least one first memory, a preset first storage space being provided in the first memory, the preset first storage space being used to store an exception log generated when an exception occurs in a UAV; and
the ground-side image transmission module comprises at least one second memory, a preset second storage space being provided in the second memory, the preset second storage space being used to store an exception log generated when an exception occurs in a remote control.

12. The UAV image transmission system according to claim 11, further comprising an image acquisition device and a mobile terminal device, wherein the UAV-side image transmission module is communicatively connected to the image acquisition device by an Ethernet, and the ground-side image transmission module is communicatively connected to the mobile terminal device by a USB.

13. The UAV image transmission system according to claim 12, wherein the image acquisition device is connected to a mass storage device of the UAV, and the mobile terminal device is connected to a mass storage device of the remote control, wherein
the UAV-side image transmission module is configured to transmit, through the Ethernet, a run log generated at an end of the UAV to the mass storage device of the UAV for storage; and
the ground-side image transmission module is configured to transmit, through the connection of the USB, a run log generated at an end of the remote control to the mass storage device of the remote control for storage, wherein
the run log generated at the end of the UAV comprises the exception log generated when an exception occurs in the UAV, and the run log generated at the end of the remote control comprises the exception log generated when an exception occurs in the remote control.

14. The UAV image transmission system according to claim 11, wherein each of the first memory and the second memory is flash, wherein
a storage address of S bytes is assigned in the flash as each preset storage space, wherein the first N bytes are used as an identifier storage region to store the end position of the exception log, and an (N+1)^{th} to an S^{th} bytes are used as a content storage region to store the exception log.
